(19) United States
(12) Patent Application Publication
(10) Pub. No.: US 2025/0061016 A1
(43) Pub. Date: Feb. 20, 2025

(54) BLOCK STATUS DATA RESET

(71) Applicant: Micron Technology, Inc., Boise, ID (US)

(72) Inventors: John M. Gonzales, Boise, ID (US); Christopher G. Wieduwilt, Boise, ID (US); Seth A. Eichmeyer, Boise, ID (US); Matthew D. Jenkinson, Boise, ID (US)

(21) Appl. No.: 18/784,572

(22) Filed: Jul. 25, 2024

Related U.S. Application Data
(60) Provisional application No. 63/519,593, filed on Aug. 15, 2023.

(51) Int. Cl. G06F 11/10

(52) U.S. Cl. CPC G06F 11/1004

(57) ABSTRACT

Apparatuses, systems, and methods for block status data reset are described. An example method includes sending a command, from a controller, to access at least one block of a first memory device. The example method further comprises receiving a failure message from the first memory device due to the at least one block being tagged as a bad block in block status data of the first memory device. The example method further comprises in response to receiving the failure message, resetting the block status data by reloading previously stored block status data from a second memory device.

### PRIORITY INFORMATION

This application claims the benefit of U.S. Provisional Application No. 63/519,593, filed on Aug. 15, 2023, the contents of which are incorporated herein by reference.

### TECHNICAL FIELD

Embodiments of the disclosure relate generally to semiconductor memory and methods, and more particularly, to apparatuses, systems, and methods related to a block status data reset.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), and synchronous dynamic random access memory (SDRAM), among others. Non-volatile memory can provide persistent data by retaining stored data when not powered and can include NAND flash memory, NOR flash memory, and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

### BRIEF DESCRIPTION OF THE DRAWINGS

FIG. 1 illustrates an example computing environment that includes a memory sub-system in accordance with some embodiments of the present disclosure.

FIG. 2 is an example memory system for a block status data reset in accordance with some embodiments of the present disclosure.

FIG. 3 is a flow diagram of an example method for a block status data reset in accordance with some embodiments of the present disclosure.

FIG. 4 is a block diagram of an example computer system in which embodiments of the present disclosure may operate.

### DETAILED DESCRIPTION

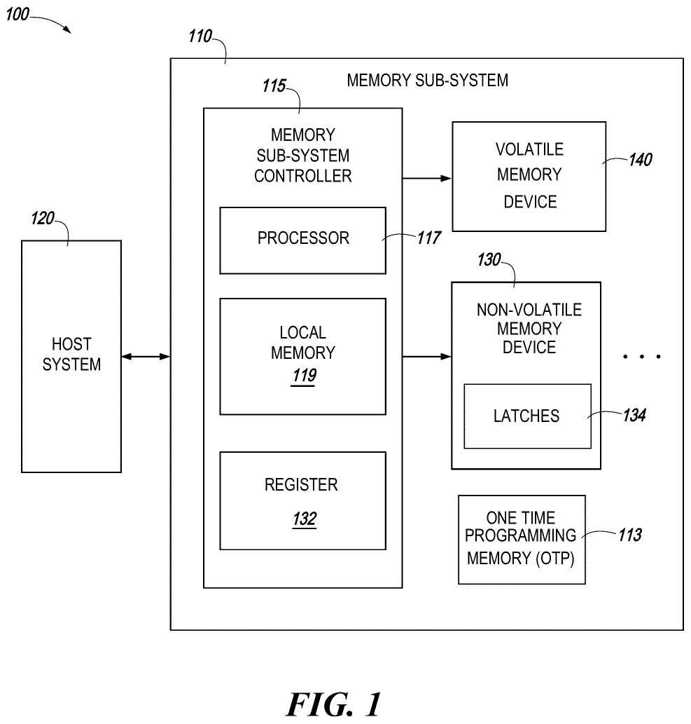

Apparatuses, systems, and methods for a block status data reset are described. A memory device can be a non-volatile memory device. One example of a non-volatile memory device is a flash memory system. Other examples of non-volatile memory devices are described below in conjunction with FIG. 1. A memory device can include a physical block of memory cells (e.g., a collection of data). The memory device can be coupled to a controller within a memory sub-system.

A memory sub-system can be a storage system, storage device, a memory module, or a combination of such. Examples of storage devices and memory modules are described below in conjunction with FIG. 1. In general, a host system can utilize a memory sub-system that includes one or more memory components (also hereinafter referred to as “memory devices”). The host system can provide data to be stored at the memory sub-system and can request data to be retrieved from the memory sub-system.

A memory operation (e.g., a read, write, or other memory operation) can be initiated to read data from and/or write data to store data in a memory device of the memory sub-system. A controller of the memory sub-system can access blocks of memory stored within a memory device and/or the data within the blocks of memory. The controller can tag the memory block as a bad block (e.g., the block is invalid, unable to properly store data, stores invalid data, etc.) or a good block (e.g., the block is valid, stores correct data, is still functioning properly, etc.) within block status data based on an indication from the memory device and/or a determination that the memory block is able to store correct data or not able to store correct data. For example, the block status data can indicate whether data within at least one memory block is valid or invalid and/or whether the block is capable of holding data without introducing an error (e.g., a “good” block can store data properly and a “bad” block is prone to errors).

The memory block can be tagged as a good block or a bad block by the memory device within latches (e.g., CMOS latches) of the memory device. The memory device can store the block status data that indicates whether each block of a plurality of blocks is a good block or a bad block in an additional memory device (e.g., a one time programming (OTP) memory device). The OTP memory device can be a second memory device while the non-volatile memory can be the first memory device. The controller can reset the block status data associated with the blocks within the memory device using the latches of the additional memory. The controller can then store the updated block status data which indicates whether one of the plurality of blocks is bad (e.g., the block status data) in the latches of the memory device.

In some instances, a latch upset event can cause one of the latches in the memory device to flip (e.g., store incorrect data about the status of a block of memory). As an example, a good block in the memory can be indicated as good in the block status data of the latches and a latch associated with the good block can be incorrectly flipped by the latch upset event, causing the good block to now be indicated as a bad block in the latches. In response to this, the controller can send a message to access data in the good block but, since the block status data has been changed, the memory indicates that the good block is now a bad block and the controller receives an error message and is unable to access the good block. To correct this, the controller can cause previously stored block status data in a one-time programmable memory to be transferred to the latches of the memory in order to correct the error in the block status data.

A latch upset event can be caused by a disruption from a particle and/or any unpredictable electrical event that results in a latch changing state. The disruption can be a neutron strike. As used herein, the term “latch upset event” refers to an occurrence that causes a latch to become inadvertently enabled or disabled. One such occurrence can be the interaction between one or more neutrons and a component of the memory device. In one example, a latch upset event can be caused by silicon particles colliding with neutrons (e.g., referred to as a neutron strike) of a latch within the memory device. The silicon particle can attract a charge and change the data within the latch. In another example, a latch upset event can be caused by alpha particles colliding with neutrons of the latch. But embodiments are not so limited, any occurrence that causes a collision with neutrons of the latch can cause a latch upset event.

The component can include, but is not limited to, an array of memory cells, latches, and logic circuitry. The errors can include, but are not limited to, changing the memory address stored in a latch or flipping a data bit. A processor on or coupled to the memory device can include error correction code (ECC) circuitry to correct the errors. However, if the number of errors exceeds the ability of the ECC circuitry to correct the errors, the memory device may function improperly.

Aspects of the present disclosure address the above and other deficiencies by storing block status data in an additional memory device (e.g., a one time programming (OTP) memory device). The controller can reset the block status data each time the controller is unable to access a block to ensure the block status data has not been changed unintentionally due to a latch upset event, such as, for example, due to a neutron strike on the latch used to store the block status data. The OTP can be used to store the block status data because the OTP may not be changed due to the same type of latch upset event and is also not modifiable. The controller can ensure the validity of the blocks of memory by resetting the block status data using the block status data stored in the OTP memory.

In order to ensure the validity of the block status data, the previously stored block status data within the OTP can be compared with the block status data stored in the controller and/or with the block status data stored in the latches of the memory device. In the event that two corresponding block status data values do not match, the block status data that is incorrect can be determined to be in error and the block status data that is incorrect can be reset. In the event that the two values do match, a determination that the block status data is still valid can be performed and no reset performed.

FIG. 1 illustrates an example computing system 100 that includes a memory sub-system 110 in accordance with some embodiments of the present disclosure. The memory sub-system 110 can include media, such as one or more non-volatile memory devices (e.g., memory device 130). In other embodiments, the memory sub-system 110 can include volatile memory devices (e.g., memory device 140) and/or a combination of volatile memory devices and non-volatile memory devices.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130, 140) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

The memory device 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory device 130 can be grouped as pages that can refer to a logical unit of the memory device used to store data. With some types of memory (e.g., NAND), pages can be grouped to form blocks.

Although non-volatile memory components such as NAND type memory (e.g., 2D NAND, 3D NAND) are described, the memory device 130 can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

In some embodiments, the memory sub-system 110 includes at least a portion of the one-time programming memory (OTP) 113. For example, the memory sub-system controller 115 can communicate with the OTP memory 113 portion to perform the operations described herein. Block status data can be stored in the OTP memory 113. Block status data can indicate whether a particular block of memory in the memory device 130, 140 is a good block or a bad block.

The memory sub-system controller 115 (or controller 115 for simplicity) can communicate with the memory devices 130, 140 to perform operations such as reading data, writing (e.g., program) data, or erasing data at the memory devices 130, 140 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. For example, the processor 117 (e.g., processing device) can be configured to execute instructions stored in local memory 119 for performing the operations described herein to read and/or write to the blocks of memory within the memory device 130 and/or read from the OTP 113.

The memory sub-system controller 115 can include a register 132 that stores block status data. The block status data stored in the register 132 can indicate whether a block in the memory device, 130, 140 is a good block or a bad block. The register 132 can store block status data that was transferred or written from block status data in the memory device 130. The memory device 130 can store the block status data in latches 134 of the memory device 130 (e.g., such as CMOS latches). In some examples, the block status data stored in the register 132 is the same as the block status data in the latches 134. In some examples, the block status data stored in the latches 134 has been corrupted or has experienced a latch upset event, as described herein. The latch upset event can cause the block status data stored in the latches 134 to be corrupted or to have a latch flip or store data different from the block status data stored in the register 134. The one time programming (OTP) memory 113 can store block status data that does not change and/or that is not corruptible. In response to the block status data in the register 132 being different from the block status data in the latches 134, block status data stored in the OTP memory 113 can be loaded into the latches 134 to remedy the error that was introduced by the latch upset event.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 130, 140. The memory sub-system controller 115 can further include host interface circuitry to communicate with the host system 120 via the physical host interface. The host interface circuitry can convert the commands received from the host system into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device 130 and/or the memory device 140.

In some embodiments, the memory device 130 includes local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The non-volatile memory device 130 can store a plurality of physical blocks of memory cells (e.g., a collection of data). The controller 115 can tag the plurality of physical blocks of memory cells to indicate the validity of at least one memory block. The block status data can be stored within the OTP memory device 113 using latches. For example, the OTP memory device 113 can include one or more latches that are configured to store an indication whether a block of the plurality of blocks of memory is a “good” block or a “bad” block. For example, the latch can store a “1” for a good block and a “0” for a bad block, etc. Although not shown in FIG. 1 so as to not obfuscate the drawings, the OTP memory device 113 can include various circuitry to facilitate data storage. For example, the OTP memory device 113 can include special purpose circuitry in the form of an ASIC, FPGA, state machine, and/or other logic circuitry that can allow the OTP memory device 113 to store the block status data.

The stored block status data within the OTP memory device 113 can be compared to the block status data of the memory block tagged as a bad block and is to be erased. In some examples, the comparison of stored block status data within the OTP memory device 113 to block status data of the memory block to be erased can occur whenever the controller 115 tags a memory block as a bad block. Prior to erasing the memory block tagged as bad by the controller 115, the controller 115 can compare the block status data of the memory block to be erased to the stored block status data within the OTP memory device 113 to ensure the memory block status data can be determined to be valid or accurate. The comparison of stored block status data to block status data can occur by the controller 115 retrieving the block status data from the OTP memory device 113 and resetting the block status data for the memory block tagged as bad. In the event that the comparison of stored block status data within the OTP memory device 115 to block status data of the memory block to be erased determines a match, the memory block can be considered valid. Likewise, in the event that the comparison does not determine a match, the memory block can be considered invalid and the stored block status data from the OTP memory device 113 can replace the invalid block status data within the controller 115. Subsequent to the replacement, if the memory block is determined to be valid, and the controller 115 can retrieve data from the memory block as well as using the memory block for reading and/or writing data.

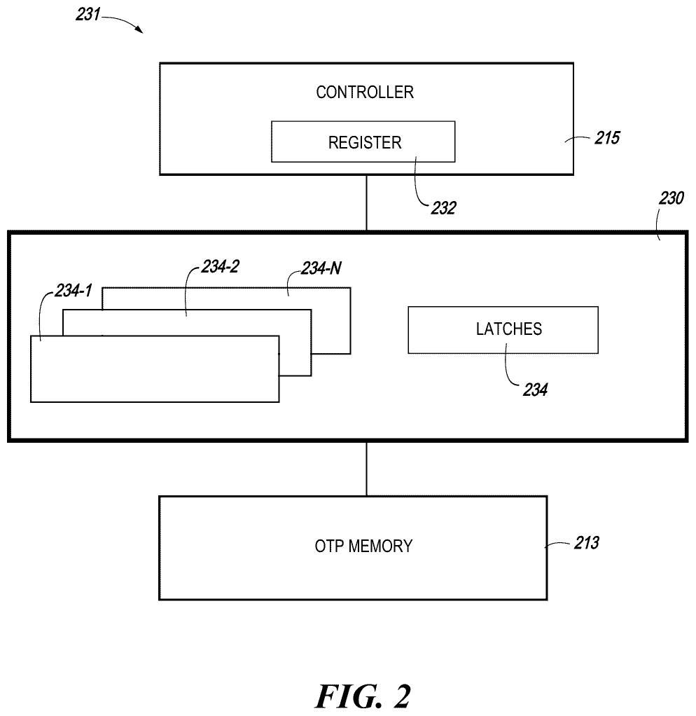

FIG. 2 is an example memory system 231 for block status data reset in accordance with some embodiments of the present disclosure. The example memory system 231 can include a memory sub-system controller 215. The memory sub-system controller 215 can tag memory blocks 234-1, 234-2, . . . , 234-N (hereinafter referred to collectively as memory blocks 234) within the non-volatile memory device 230 as good blocks or bad blocks and store the block status data within the OTP memory device 213 (e.g., analogous to the OTP memory device 113 illustrated in FIG. 1) and/or within latches 234 (e.g., CMOS latches) of the memory device 230 . . . . Although only one portion of blocks of memory cells is illustrated, embodiments are not so limited and an unlimited amount of portions of blocks of memory may be within the non-volatile memory device, whose block status data can be stored partially or entirely within the OTP memory device 213. The block status data can indicate the validity of each memory block. For example, the block status data can indicate whether a block is a good block or a bad block of data, e.g., whether the controller can read, erase, program or write data to the memory block 234 without creating errors.

In some examples, the controller 215 can tag at least one of the memory blocks 234 in the non-volatile memory device 230 responsive to an attempt to read, erase, program or write data to at least one of the memory blocks 234. The controller 215 can tag the at least one memory block 234 as bad responsive to being unable to read, erase, program or write data to the memory block 234. The controller 215 can send a message requesting to program an empty memory block (e.g., attempt to program an empty memory block) within the non-volatile memory device 230 and tag the empty memory block as bad responsive to being unable to program the memory block. The controller 215 may be prevented from programming the memory block due to the block status data in the latches 234 of the memory device 230 indicating that the empty memory block is a bad block. The latches 234 may be incorrectly tagging the empty memory block as a bad block due to a latch upset event. Further, responsive to the controller 215 tagging a memory block as a bad block, the controller 215 can disable the memory block 234 and prevent access to the memory block 234. However, to avoid the controller 215 tagging the empty memory block as a bad block in response to receiving a failure message from the memory device 230 (due to the block status data in the latches 234 of the memory device indicating the empty memory block is a bad block), the controller 215, as part of the failure recovery process, can load block status data from the OTP memory 213 into the latches 234 and/or into the register 232 of the controller 215 in order to correct any errors and/or to remedy any errors introduced by a latch upset event.

In some examples, the block status data can indicate whether the block is a good block or a bad block and whether the controller 215 will permit access to the memory block 234. The block status data can be stored within the OTP memory device 213.

Prior to erasing a memory block within the non-volatile memory 230 that has been tagged by the controller 215 as a bad block, the controller 215 can compare the block status data stored within the OTP memory device 213 to the block status data of the memory block to be erased. The comparison of the block status data of the memory block to be erased to the block status data within the OTP memory device 213 can occur in order to verify the block status data prior to erasing the memory block. In response to the comparison indicating that the block status data of the OTP 213 and the latches 234 not matching, the controller 215 can retrieve the block status data within the OTP memory device 213 and reset the block status data for the memory block to be erased with the block status data within the OTP memory device. 213.

A latch upset event can be defined as an occurrence that causes a latch to become inadvertently enabled. For example, the latch upset event can flip a latch of the memory device 230 that indicates whether a particular block in the memory device 230 is a bad block or a good block. A latch upset event can prevent the controller 215 from accessing data within the particular block due to the latches 234 of the memory device 230 incorrectly indicating that the particular block is a bad block. A comparison of the block status data can indicate that a latch upset event occurred. For example, when there is a difference between the block status data of the memory block to be erased and the block status data of the OTP memory device 213, a determination that an error has occurred can be made.

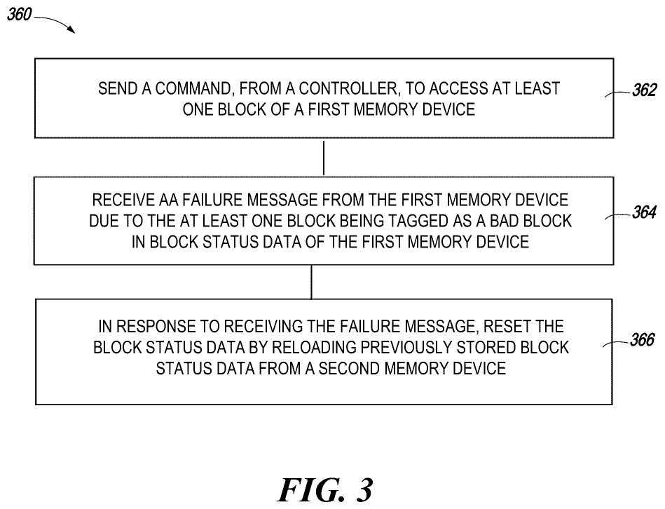

FIG. 3 is a flow diagram of an example method 360 corresponding to status data in accordance with some embodiments of the present disclosure. The method 360 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 360 can be performed by the memory sub-system controller 115 and 215 of FIGS. 1 and 2 respectively. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 362, the method 360 includes sending a command, from a controller, to access at least one block of a non-volatile memory (e.g., the non-volatile memory 130, 230 illustrated in FIGS. 1-2). In some examples, the controller (e.g., the controller 115, 215 illustrated in FIGS. 1-2) can send a command to the non-volatile memory to access the at least one memory block of non-volatile memory to erase the data within.

At operation 364, the method 360 includes receiving a failure message from the non-volatile memory due to the at least one block being tagged as a bad block in block status data of the non-volatile memory. The controller may be prevented from accessing the at least one memory block due to the block status data in the latches of the memory device indicating that the memory block is a bad block. The latches may be incorrectly tagging the empty memory block as a bad block due to a latch upset event.

At operation 366, the method 360 includes, in response to receiving the failure message, resetting the block status data by reloading previously stored block status data from an additional memory device. To avoid the controller tagging the empty memory block as a bad block, the controller, as part of the failure recovery process, can load block status data from previously stored block status data. The memory sub-system controller can previously store the memory status data associated with the at least one memory block within an additional memory device (e.g., the OTP memory device 113, 213 illustrated in FIGS. 1-2, respectively). The previously stored status data within the additional memory device can be reloaded into the latches of the non-volatile memory device and/or into the register of the controller in order to correct any errors introduced by a latch upset event. The controller can make a determination as to the validity of the memory block by resetting the block status data. The controller can reset the block status data by retrieving the block status data previously stored within the additional memory device. Further, the previously stored block status data can be compared to the block status data in the latches of the non-volatile memory device. In the event that the two block status data values do not match, the block status data of the at least one memory block can be determined to be in error and invalid. In the event that the two block status data values do match, a determination both that the memory block is valid and that the memory block is a bad block to be erased can be made.

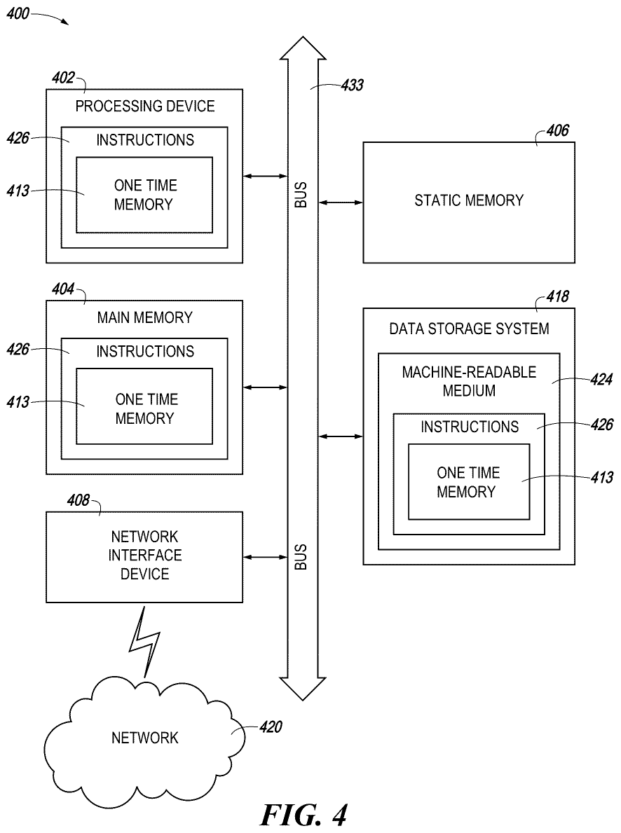

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to tag memory blocks) and of the OTP memory device 413 (e.g., to store memory block tags that indicate the validity of the memory blocks within the non-volatile memory). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 433.

The processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and stages discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality using data stored in the OTP memory device 413. While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
sending a command, from a controller, to access at least one block of a first memory device;
receiving a failure message from the first memory device due to the at least one block being tagged as a bad block in block status data of the first memory device; and
in response to receiving the failure message, resetting the block status data by reloading previously stored block status data from a second memory device.

2. The method of claim 1, further comprising retrieving the previously stored block status data from a one-time programming (OTP) memory device.

3. The method of claim 1, wherein the block status data is stored within complementary metal-oxide semiconductor (CMOS) latches of the first memory device.

4. The method of claim 1, further comprising comparing data of the block status data associated with the at least one block of the first memory device to data of the previously stored block status data within the second memory device.

5. The method of claim 4, further comprising writing data to the at least one block of the first memory device responsive to the data of the block status data associated with the at least one block of the first memory device not matching the previously stored blocks status data within the second memory device.

6. The method of claim 1, further comprising reading and retrieving data from the at least one block of the first memory device subsequent to the reset.

7. An apparatus, comprising:
a non-volatile memory comprising a plurality of blocks of memory; and
a controller coupled to the non-volatile memory and configured to:
send a command to program at least one block of the non-volatile memory;
receive a failure message from the non-volatile memory due to the at least one block being tagged as a bad block in block status data of the non-volatile memory;
in response to receiving the failure message, reset the block status data by reloading previously stored block status data from a one-time programming (OTP) memory device; and
determine a validity of the at least one block responsive to a comparison of the block status data of the non-volatile memory to the previously stored block status data from a one-time programming (OTP) memory device.

8. The apparatus of claim 7, wherein the controller is configured to prevent access to any block of memory that is determined to be a bad block.

9. The apparatus of claim 7, wherein the block status data within the controller is the same as the block status data within the non-volatile memory.

10. The apparatus of claim 7, wherein the controller is configured to tag the memory block using latches.

11. The apparatus of claim 7, wherein the controller is configured to determine that a latch upset event has occurred responsive to a difference between the block status data and the previously stored block status data.

12. The apparatus of claim 11, wherein the latch upset event is an occurrence of an unpredictable electrical event that results in a latch changing state.

13. An apparatus, comprising:
non-volatile memory; and
controller coupled with the memory and configured to cause the apparatus to:
send a command, from a controller, to erase data within at least one block of the non-volatile memory;
receive a failure message from the non-volatile memory due to the at least one block being tagged as a bad block in block status data of the non-volatile memory;
in response to receiving the failure message, compare the block status data of the at least one block tagged as a bad block to previously stored block status data from a one-time programming (OTP) memory device; and
reset the block status data of the at least one block by reloading the previously stored block status data from the OTP memory device responsive to the block status data of the at least one block not matching the previously stored block status data.

14. The apparatus of claim 13, wherein the controller is configured to determine that a latch upset event has occurred responsive to the block status data of the at least one block not matching the previously stored block status data.

15. The apparatus of claim 13, wherein the controller is configured to disable the at least one block of the non-volatile memory responsive to the block status data of the at least one block not matching the previously stored block status data.

16. The apparatus of claim 13, wherein the controller is configured to determine the at least one block is invalid responsive to the block status data of the at least one block not matching the previously stored block status data.

17. The apparatus of claim 13, wherein the controller is configured to erase the data within the at least one block of the non-volatile memory considered a bad block responsive to the block status data of the at least one block matching the previously stored block status data.

18. The apparatus of claim 13, wherein the at least one block of the non-volatile memory is determined to be valid responsive to the block status data of the at least one block matching the previously stored block status data.

19. The apparatus of claim 13, wherein the block status data is loaded into latches within the non-volatile memory device responsive to the block status data of the at least one block not matching the previously stored block status data.

20. The apparatus of claim 13, wherein the block status data of the at least one block within the non-volatile memory is similar to a block status data within a register in the controller.
